(19) United States
(12) Patent Application Publication
(10) Pub. No.: US 2009/0085246 A1
(43) Pub. Date: Apr. 2, 2009

(54) METHOD FOR PRODUCING FILM

(75) Inventors: Kousuke YAMAKI, Kanagawa (JP); Toshinao ARAI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/234,666

(22) Filed: Sep. 21, 2008

(30) Foreign Application Priority Data
Sep. 28, 2007 (JP) 2007-255267

(51) Int. Cl. B29D 7/01

(52) U.S. Cl. 264/217

(57) ABSTRACT

Dope is cast onto a moving casting drum to form a casting film. After being cooled to be solidified, the casting film is peeled as a wet film from the casting drum. A residual amount of solvent in the casting film at the time of peeling it from the casting drum is denoted by W. In a first tenter, while being dried, the wet film is stretched in its width direction to form an intermediate film. Before the residual amount of solvent in the wet film reaches (W-100) wt %, the wet film is widened in its width direction such that the increased width is not less than 105% and not more than 130% of the width before the width increasing. The intermediate film is stretched and widened in its width direction in the second tenter such that the increased width is not less than 110% and not more than 160% of the width before the width increasing. Thus, it is possible to produce a film having optical properties in which Re is high and a value of Rth/Re is decreased in comparison with conventional films.

### FIELD OF THE INVENTION

The present invention relates to a method for producing a film.

### BACKGROUND OF THE INVENTION

A liquid crystal display (LCD) has a structure in which a plurality of optical films are stacked. As to the LCD, there is required an optical film which has various optical properties corresponding to various kinds of displaying types in the LCD. It is necessary for the optical film to have various optical properties corresponding to the kind, type, and the like of the LCD, in particular. The optical properties are, for example, an in-plane retardation (nm) (hereinafter, referred to as “Re”), a retardation (nm) in a thickness direction (hereinafter, referred to as “Rth”), and a haze value (%). The “in-plane” refers to a direction of the plane vertical to the thickness direction of the film.

As well known, the Re and the Rth are calculated by the following mathematical expressions (1) and (2) respectively. Note that, in the mathematical expressions (1) and (2), “nx” is a refractive index in a slow axis direction in the in-plane of the film, “ny” is a refractive index in a fast axis direction in the in-plane of the film, “nz” is a refractive index in the film thickness direction, and “d” is a thickness (nm) of the film.

Re=(nx−ny)×d (1)

Rth={(nx+ny)/2−nz}×d (2)

A polymer film, in particular, a film whose raw material is cellulose acylate is stretched, and the orientation of polymer molecules in the film is adjusted such that Re and Rth are controlled. Thereby, the film is used as, in particular, a phase difference film for the LCD. The phase difference film is incorporated in a polarizing plate. As the Re is increased, a width increasing ratio in stretching is increased, and thereby the Rth is also increased. However, recently, there is required an optical film for use in the phase difference film of the polarizing plate, which has the optical properties in which the Re is high and the Rth is lower than the Re. The phrase “the Rth is lower than the Re” means that a value of Rth/Re is smaller than that of a conventional film by at least 1, namely, nearer to 1.

As a method for controlling Re and Rth of the polymer film, there are the following methods. For example, in Japanese Patent Laid-Open Publication No. 2002-187960, a cellulose ester solution is cast onto a support to form a casting film, and then the casting film is peeled as a wet film from the support. The wet film is dried while the residual amount of solvent in the wet film is within a predetermined range. Further, while being dried, the wet film is stretched in the width direction thereof in order to produce a film having high Re and Rth. Moreover, in Japanese Patent Laid-Open Publication No. 2002-311245, while the residual amount of solvent in the casting film is within a predetermined range, the casting film is peeled as the film, and the film is stretched at two stages in the width direction thereof in order to produce a film having low Re. Further, as disclosed in U.S. Pat. No. 7,166,339 (corresponding to Japanese Patent Translation Publication No. 2000-065384), there is a method for forming a film in which a retardation increasing agent is added to the polymer solution such that Re is increased.

In a method disclosed in Japanese Patent Laid-Open Publication No. 2002-187960, the casting film is easily broken since the residual amount of solvent in a casting film is high, and therefore it is impossible to speed up the stretching speed and increase the stretching ratio in the width direction. Moreover, in a case where a drum is used as the casting support for the purposed of increasing the productivity and the casting film is solidified to have a self-supporting property and peeled from the drum, namely in a cooling casting method, at the time of peeling the casting film, the molecules are oriented toward the transporting direction of the wet film, and therefore Rth of the film after the stretching process is increased. Accordingly, in the cooling casting method, although the Re can be increased, the value of Rth/Re cannot be decreased.

In the method disclosed in Japanese Patent Laid-Open Publication No. 2002-311245, the film is stretched with the use of a first tenter and a second tenter disposed in the downstream side from the first tenter. The residual amount of solvent in the film to be transported to the first tenter is kept at least 10 mass % and at most 50 mass %. Therefore, in order to dry the film before the film reaches the first tenter such that the residual amount of solvent becomes the above range, it is necessary to dry the casting film on the support. However, when the casting film is dried on the support and then peeled therefrom as described above, namely in a drying casting method, it is impossible to achieve the productivity equivalent to that of the cooling casting method. Further, in this method, it is impossible to produce a film having high Re. On the contrary, in a method disclosed in U.S. Pat. No. 7,166,339, since the retardation increasing agent is added to the casting film, it is possible to increase Re, however, Rth is also increased. Therefore, it is impossible to achieve the desired optical properties.

Additionally, it is necessary to increase a stretching ratio in a width direction of the film such that the value of Re becomes higher. However, when the dried film whose residual amount of solvent is small is stretched, the film tends to have white streaks due to the stretching and the haze value is increased. On the contrary, in a case where the casting film whose residual amount of solvent is still large is stretched, the value of Re can be higher without increasing the value of haze in the film in some cases. However, as described in Japanese Patent Laid-Open Publication No. 2002-187960, when the casting film whose residual amount of solvent is still large is subjected to width increasing, the casting film is easily broken. Accordingly, it has been difficult to produce a film in which the value of Re is high and the value of haze is suppressed to low.

### SUMMARY OF THE INVENTION

In view of the foregoing, an object of the present invention is to provide a method for producing an optical film in which molecular orientation in a width direction of the film is high, a value of Re is high, a value of Rth is lower than the value of Re, and a value of haze is low, in comparison with the conventional optical films. Here, the expression “the value of haze is low” means that the value of haze is suppressed to low such that the value of Re/haze is at least 130.

A film producing method of the present invention includes the following steps. Dope is cast on a moving support to form a casting film. The dope contains cellulose acylate and solvent. The casting film after being solidified by cooling is peeled as a film from the support. The film is subjected to first stretching in its width direction while being dried. The solvent contained in the film evaporates therefrom by the drying. The film after the first stretching is subjected to second stretching in its width direction while being heated. The width of the film is increased during the first stretching until the residual amount of the solvent contained in the film reaches (W-100) wt %. The increased width is not less than 105% and not more than 130% of the width before the width increasing. The width of the film is increased during the second stretching. The increased width is not less than 110% and not more than 160% of the width before the width increasing. Note that the residual amount of solvent contained in the casting film at the time of peeling the casting film from the support is denoted by W (unit; wt %).

According to the present invention, it is possible to efficiently produce an optical film having Re of at least 30 (nm) and Rth lower than the Re.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is a schematic view of a dope producing apparatus;

FIG. 2 is a schematic view of a solution casting apparatus according to a first embodiment of the present invention;

FIG. 3 is a schematic view of a wet film held in a first tenter;

FIG. 4 is an explanation view showing an increase in a width of the wet film in the first tenter;

FIG. 5 is an explanation view showing an increase and a decrease in a width of an intermediate film in a second tenter; and

FIG. 6 is a schematic view of an off-line stretching apparatus according to a second embodiment of the present invention.

### DESCRIPTION OF THE PREFERRED EMBODIMENTS

Hereinafter embodiments of the present invention are described in detail. However, the present invention is not limited to the following embodiments.

[Raw Material of Dope]

As a raw material of dope, cellulose acylate is used as a solute. As a solvent, as long as the solvent can dissolve the cellulose acylate, the solvent is not especially limited. Here, the dope refers to a polymer solution or a dispersion liquid obtained by dissolving or dispersing polymer(s) in the solvent. Note that, cellulose acylate is described in detail in paragraphs [0140] to [0195] in Japanese Patent Laid-Open Publication No. 2005-104148. These descriptions are also applicable to the present invention.

Solvent compounds for preparing the dope are, for example, aromatic hydrocarbon (for example, benzene, toluene, and the like), halogenated hydrocarbons (for example, dichloromethane, chlorobenzene, and the like), alcohols (for example, methanol, ethanol, n-propanol, n-butanol, diethyleneglycol, and the like), ketones (for example, acetone, methylethyl ketone, and the like), esters (for example, methylacetate, ethylacetate, propylacetate, and the like), ethers (for example, tetrahydrofuran, methylcellosolve, and the like), and the like.

Among the solvent compounds, the halogenated hydrocarbons having 1 to 7 carbon atoms are preferable, and dichloromethane is most preferable. In view of physical properties such as solubility of cellulose acylate, peelability of a casting film from a support, mechanical strength and optical properties of the film, it is preferable to use at least one sort of the alcohols having 1 to 5 carbon atoms with dichloromethane. The content of the alcohols is preferably in the range of 2 wt % to 25 wt %, and more preferably in the range of 5 wt % to 20 wt % relative to the total solvent compounds in the solvent. Specific examples of the alcohols are methanol, ethanol, n-propanol, isopropanol, n-butanol, and the like. Among them, methanol, ethanol, n-butanol, or a mixture of them is preferably used.

Further, various additives are added to the dope. As such additives, there are plasticizers, deterioration inhibitors, UV absorbents, optical anisotropy controllers, dyes, matting agents, and peeling agents which are described in detail in paragraphs [0196] to [0516] of Japanese Patent Laid-Open Publication No. 2005-104148, and retardation increasing agents which is described in detail in paragraphs [0030] to [0142] of Japanese Patent Laid-Open Publication No. 2006-235483. These descriptions are also applicable to the present invention.

[Dope Producing Method]

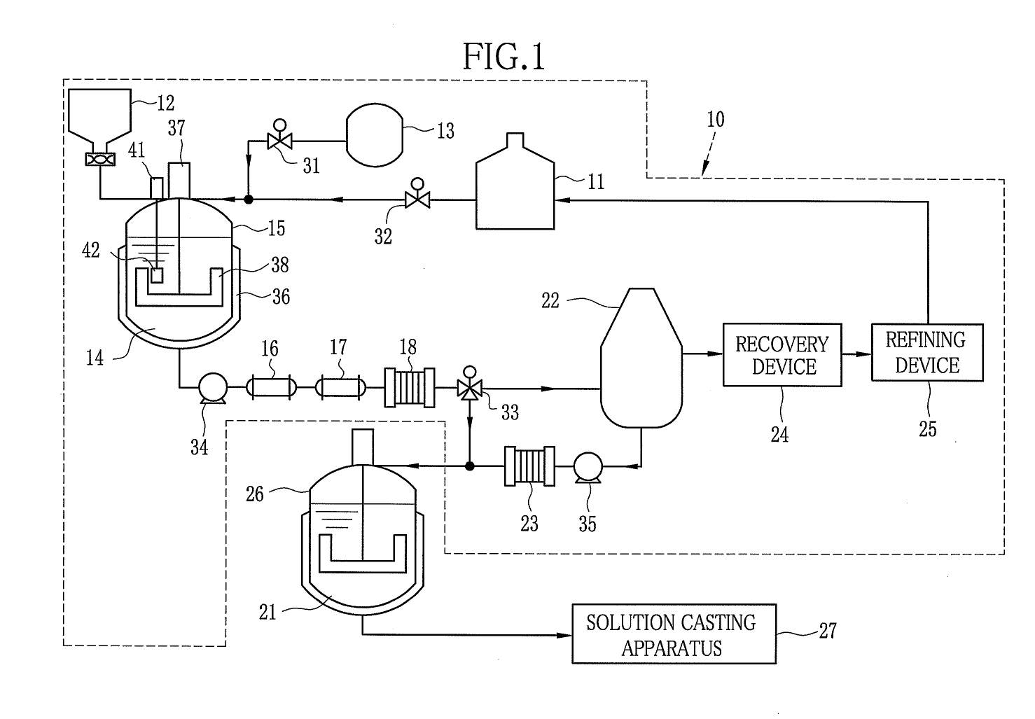

As shown in FIG. 1, a dope producing apparatus 10 includes a solvent tank 11, a hopper 12, an additive tank 13, a mixing tank 15, a heater 16, a temperature regulator 17, a filtration device 18, a flash device 22, and a filtration device 23.

The solvent tank 11 stores a solvent. The hopper 12 supplies the cellulose acylate. The additive tank 13 stores an additive. In the mixing tank 15, the solvent, the cellulose acylate, and the additive are mixed to obtain a mixture 14 which is in a liquid state. The mixture 14 is heated by the heater 16. The temperature regulator 17 adjusts temperature of the heated mixture 14. The mixture 14 sent from the temperature regulator 17 is filtered through the filtration device 18 to obtain a dope 21. The flash device 22 adjusts concentration of the dope 21 sent from the filtration device 18. Thereafter, the dope 21 is filtered through the filtration device 23.

The dope producing apparatus 10 further includes a recovery device 24 and a refining device 25. The recovery device 24 recovers the solvent. The refining device 25 refines the recovered solvent. The dope producing apparatus 10 is connected to a solution casting apparatus 27 via a stock tank 26. Valves 31 to 33 and pumps 34 and 35 are provided in the dope producing apparatus 10. The valves 31 to 33 adjust liquid flow amounts. The pumps 34 and 35 feed liquids. The positions of the valves 31 to 33 and the pumps 34 and 35, and the number of the pumps may be changed as necessary.

The dope 21 is produced by the following method using the dope producing apparatus 10. By opening the valve 32, the solvent is fed from the solvent tank 11 to the mixing tank 15. Next, the cellulose acylate is fed from the hopper 12 to the mixing tank 15. Cellulose acylate may be continuously fed to the mixing tank 15 using a feeding device (not shown) which continuously measures the amount of the cellulose acylate while feeding it. Alternatively, the cellulose acylate may be intermittently fed to the mixing tank 15 using a feeding device (not shown) which feeds a predetermined amount of the cellulose acylate after measuring the amount of the cellulose acylate. By opening and closing the valve 31, a necessary amount of the additive solution is fed from the additive tank 13 to the mixing tank 15.

The additive may be fed in the state of a solution. Further, in a case where the additive is in the liquid state at room temperature, the additive in the liquid state may be fed to the mixing tank 15. In a case where the additive is in the solid state, the additive may be fed to the mixing tank 15 using a hopper or the like. In a case where plural additives are added, a solution into which the plural additives are dissolved may be put in the additive tank 13. Alternatively, plural additive tanks may be used. In this case, each additive tank contains a solution in which an additive is dissolved. Each additive tank is connected to the mixing tank 15 through an independent pipe to feed the solution.

As described above, the solvents, the cellulose acylate, and the additives are put in the mixing tank 15 in this order. However, the order is not limited thereto. The additive is not necessarily mixed with the cellulose acylate and the solvent in the mixing tank 15. The additive may be mixed with a mixture of the cellulose acylate and the solvent by an in-line mixing method or the like in a subsequent process.

It is preferable that the mixing tank 15 is provided with a jacket 36, a first stirrer 38, and a second stirrer 42. The jacket 36 covers an outer surface of the mixing tank 15. A heat transfer medium is supplied to a space between the jacket 36 and the mixing tank 15. The first stirrer 38 is rotated by a motor 37. The second stirrer 42 is rotated by a motor 41. The temperature of the mixing tank 15 is adjusted by the heat transfer medium flown into the jacket 36, and a preferable temperature range thereof is −10° C. to 55° C. The first stirrer 38 and the second stirrer 42 are selectively used for stirring the solvent, the cellulose acylate, and the additive. Thus, the mixture 14 in which the cellulose acylate is swelled by the solvent is obtained. It is preferable that the first stirrer 38 has an anchor blade, and the second stirrer 42 is an eccentric stirrer of a dissolver type.

Next, the mixture 14 is fed to the heater 16 using the pump 34. It is preferable that the heater 16 is a pipe (not shown) with a jacket. A heat transfer medium is caused to pass between the pipe and the jacket. In addition, it is preferable that the heater 16 has a pressurizing section (not shown) to pressurize the mixture 14. With the use of the heater 16, solid contents in the mixture 14 are effectively and efficiently dissolved under a heated condition, or a pressurized and heated condition. Hereinafter, a method in which the solid contents are dissolved into the solvent by heating as described above is referred to as a heat-dissolving method. In the heat-dissolving method, it is preferable to heat the mixture 14 to a temperature in a range of 0° C. to 97° C.

Alternatively, a cool-dissolving method may be used to dissolve the solid contents into the solvent. In the cool-dissolving method, dissolution of the solid contents is enhanced while the mixture 14 is kept at a predetermined temperature, or cooled to a low temperature. In the cool-dissolving method, it is preferable to cool the mixture 14 to a temperature in a range of −100° C. to −10° C. With the use of the above heat-dissolving method or the cool-dissolving method, the cellulose acylate can be sufficiently dissolved into the solvent.

After the temperature of the mixture 14 is adjusted to approximately room temperature using the temperature regulator 17, the mixture 14 is filtered through the filtration device 18 to remove foreign substances such as impurities and aggregations. Hereinafter, the mixture 14 is referred to as the dope 21. An average pore diameter of the filter used in the filtration device 18 is preferably not more than 100 μm. It is preferable that a filtration flow volume is not less than 50 liter/hr.

After the filtration, the dope 21 is fed to the stock tank 26 through the valve 33, and temporarily stored therein. Thereafter, the dope 21 is used for the film production.

As described above, the method in which the solid contents are swelled once and then dissolved to prepare the solution requires longer time for preparing the dope, and especially when the concentration of the cellulose acylate in the solution is increased, the required tome becomes longer. Such a method has a problem in production efficiency in some cases. In this case, it is preferable to prepare a dope having a concentration lower than that required once, and then concentrate the dope to achieve the required concentration. For example, the dope 21 after the filtration through the filtration device 18 is fed to the flash device 22 through the valve 33, and a part of the solvent in the dope 21 is evaporated for concentration in the flash device 22. The concentrated dope 21 is taken out of the flash device 22 using the pump 35, and fed to the filtration device 23. It is preferable that the temperature of the dope 21 is in a range of 0° C. to 200° C. at the time of filtration. The dope 21 from which foreign substances are removed through the filtration device 23 is fed to the stock tank 26 and temporarily stored therein. Thereafter, the dope 21 is used for the film production. Note that, the concentrated dope 21 contains foams in some cases. In such a case, it is preferable to perform defoaming before the dope 21 is fed to the filtration device 23. Various known defoaming methods such as a method for radiating ultrasound to the dope 21 may be used.

The solvent vapors generated by flash evaporation in the flash device 22 are condensed in the recovery device 24 having a condenser (not shown). Thereby, the solvent vapors are condensed into a liquid and recovered. The recovered solvent is refined as a solvent for preparing the dope in the refining device 25, and reused in the dope production. Such recovering and refining of the solvent vapors are advantageous in reducing production cost. In addition, since recovering and refining are performed in a closed system, adverse effects to humans and the environment can be prevented.

Thus, the dope 21 having the cellulose acylate concentration of not less than 5 wt % and not more than 40 wt % can be produced. It is more preferable that the cellulose acylate concentration is not less than 15 wt % and not more than 30 wt %. It is furthermore preferable that the cellulose acylate concentration is not less than 17 wt % and not more than 25 wt %. Preferably, the additive concentration is not less than 1 wt % and not more than 20 wt % relative to the total solid content.

The dissolving method, the filtration method, the defoaming method, and the adding method of the materials, war materials, and additives in the solution casting method for forming cellulose acylate film are described in detail in paragraphs [0517] to [0616] in Japanese Patent Laid-Open Publication No. 2005-104148. These descriptions are also applicable to the present invention.

[Apparatus and Method for Producing Film]

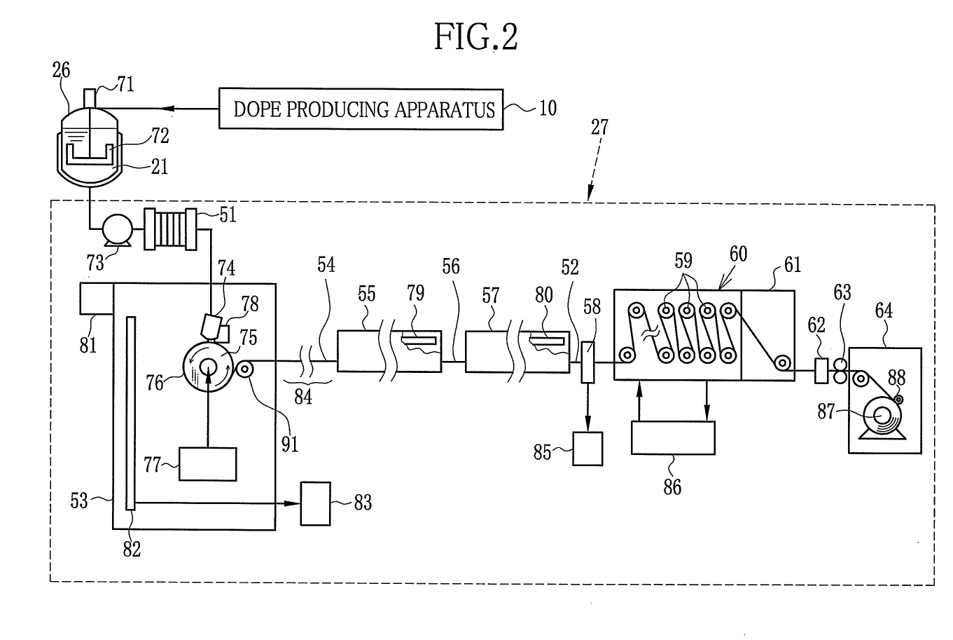

As shown in FIG. 2, the solution casting apparatus 27 has a filtration device 51, a casting chamber 53, a first tenter 55, a second tenter 57, an edge slitting device 58, a drying chamber 60, a cooling chamber 61, a neutralization device 62, a pair of knurling rollers 63, and a winding chamber 64. The edge slitting device 58 cuts off the side edge portions of the film 52 fed from the second tenter 57. In the drying chamber 60, the film 52 is bridged over a plurality of rollers 59 to be transported while being dried.

The filtration device 51 removes foreign substances from the dope 21 fed from the stock tank 26. In the casting chamber 53, the dope 21 filtered through the filtration device 51 is cast onto a casting drum 75 described later to form a casting film 76. Then, the casting film 76 is peeled as a wet film 54 therefrom. In the first tenter 55, the wet film 54 is dried while being transported in a state that side edge portions thereof are held (kept). While being dried, the wet film 54 is stretched in the width direction thereof. Hereinafter, a stretching process while the film is dried as described above is referred to as a first stretching process. The film after being dried in the first tenter 55 is referred to as an intermediate film 56. In the second tenter 57, while being transported, the intermediate film 56 fed from the first tenter 55 is heated to be dried. During the heating, the intermediate film 56 is stretched and the width thereof is increased, to obtain the cellulose acylate film (hereinafter referred to as a film) 52. Hereinafter, a stretching process while the film is heated as described above is referred to as a second stretching process. The film 52 is cooled in the cooling chamber 61. An amount of voltage applied to the film 52 is reduced in the neutralization device 62. The both side edge portions of the film 52 is subjected to embossing processing using the pair of knurling rollers 63. Next, the film 52 is wound in the winding chamber 64.

A stirrer 72 is attached to the stock tank 26. The stirrer 72 is rotated by a motor 71. The dope 21 is stirred by the rotation of the stirrer 72. Thereafter, the dope 21 in the stock tank 26 is fed to the filtration device 51 using a pump 73.

The casting chamber 53 includes a casting die 74 and the casting drum 75. The dope 21 is cast through the casting die 74 onto an outer peripheral surface of the casting drum 75 as the support.

The casting drum 75 is provided with a heat transfer medium circulator 77. The heat transfer medium circulator 77 supplies a heat transfer medium inside the casting drum 75 to control the temperature of the outer peripheral surface of the casting drum 75. A flow path (not shown) for the heat transfer medium is formed inside the casting drum 75. The temperature of the outer peripheral surface of the casting drum 75 is kept at a predetermined value by passing the heat transfer medium kept at a predetermined temperature through the flow path. The temperature of the outer peripheral surface of the casting drum 75 is set at an appropriate value in accordance with a kind of the solvent, kinds of solid contents, a concentration of the dope 21, and the like.

A decompression chamber 78 is provided at the vicinity of the casting die 74. The decompression chamber 78 sucks air from an area in an upstream side from the casting bead formed so as to extend from the casting die 74 to the casting drum 75 in the rotational direction of the casting drum 75. Thereby, decompression is performed in the area in an upstream side from the casting bead.

The casting chamber 53 includes a temperature controlling device 81 and a condenser 82. The temperature controlling device 81 keeps the inner temperature of the casting chamber 53 at a predetermined value. The condenser 82 condenses and recovers solvent vapors evaporated from the dope 21 and the casting film 76. A recovery device 83 is provided outside the casting chamber 53. The recovery device 83 recovers the condensed and liquefied solvent.

An air blower (not shown) may be provided in a transfer section 84 extending from the casting chamber 53 to the first tenter 55.

In the first tenter 55, the wet film 54 is transported with its side edge portions held. During the transportation, the wet film 54 is stretched while being dried, to obtain the intermediate film 56. The first tenter 55 is provided with an air duct 79 for supplying dry air thereto.

In the second tenter 57, the intermediate film 56 is transported with its side edge portions held. During the transportation, the intermediate film 56 is stretched while being heated, to obtain the film 52. The second tenter 57 is provided with an air duct 80 for supplying dry air thereto as in the case of the first tenter 55.

Further, the edge slitting device 58 is provided with a crusher 85 for crushing the side edge portions of the film 52 thus cut off into chips.

An adsorption and recovery device 86 is attached to the drying chamber 60. The adsorption and recovery device 86 adsorbs and recovers solvent vapors evaporated from the film 52. The cooling chamber 61 is provided at the downstream side from the drying chamber 60. A moisture control chamber (not shown) may be further provided between the drying chamber 60 and the cooling chamber 61 so as to adjust a water content in the film 52.

The neutralization device 62 is a so-called compulsory neutralization device such as a neutralization bar, and adjusts the voltage applied to the film 52 within a predetermined range. The installation position of the neutralization device 62 is not limited to the downstream side from the cooling chamber 61. The pair of knurling rollers 63 provides knurling to the both side edge portions of the film 52 by embossing processing. A winding shaft 87 and a press roller 88 are provided in the winding chamber 64. The winding shaft 87 winds the film 52. The tension at the time of winding is controlled by the press roller 88.

Next, according to a first embodiment of the present invention, a method for producing the film 52 using the solution casting apparatus 27 is described hereinbelow. The dope 21 is fed to the stock tank 26, and made constantly uniform by the rotation of the stirrer 72. Thereby, precipitation and coagulation of the solid contents of the dope 21 can be prevented until the casting. Various additives may be appropriately mixed with the dope 21 during the stirring of the dope 21. The foreign substances having a diameter larger than a predetermined particle diameter and those in a gel state are removed from the dope 21 through filtration using the filtration device 51.

After the filtration, the dope 21 is cast through the casting die 74 onto the casting drum 75. It is preferable that the temperature of the dope 21 at the time of casting is constant within a range of 30° C. to 35° C. It is preferable that the temperature of the outer peripheral surface of the casting drum 75 is constant within a range of −10° C. to 10° C. Preferably, the temperature of the casting chamber 53 is controlled by the temperature controlling device 81 so as to be within the range of 10° C. to 30° C. Note that, the solvent vapors evaporated inside the casting chamber 53 are recovered by the recovery device 83. Thereafter, the recovered solvent is refined and recycled as the solvent for use in the dope preparation.

The casting bead extends from the casting die 74 to the casting drum 75 so as to form the casting film 76 on the casting drum 75. The casting film 76 is cooled and turns into a gel state to be solidified to have a self-supporting property on the casting drum 75. The solidified casting film 76 is peeled from the casting drum 75 with the support of a peel roller 91 to obtain the wet film 54. The casting film 76 may be peeled from the casting drum 75 when the casting film 76 achieves sufficient hardness for transportation, regardless of the residual amount of solvent in the casting film 76. However, it is preferable that the casting film 76 is peeled from the casting drum 75 before the residual amount of solvent in the casting film 76 achieves 200 wt %. The residual amount of solvent is a value on dry basis. To be more specific, in the present invention, the residual amount of solvent in the film is calculated by a mathematical formula {x/(y−x)}×100 where x is a weight of the solvent and y is a weight of the casting film 76 or a film to be described later. Hereinafter, the residual amount of solvent in the casting film 76 at the time of peeling is referred to as “W”.

In view of production efficiency, it is preferable to cool the casting film 76 so as to achieve sufficient hardness even when the residual amount of solvent W in the casting film 76 at the time of peeling is high. When the expose surface of the casting film 76 is sufficiently hardened by the cooling, dry air may be supplied to the vicinity of the casting film 76 so as to improve stability of the casting film 76 during transportation after the casting film 76 is peeled off. In order to achieve a high production speed of at least 50 m/min, it is preferable to cool the casting film 76 quickly so that the casting film 76 is sufficiently hardened for peeling even when the residual amount of solvent is 140% or more. In a case where the temperature for cooling the casting film 76 is low, it may be necessary to upsize the casting drum 75 for the purpose of increasing time for transporting the casting film 76. Moreover, in a case where the residual amount of solvent is higher than 320%, it is difficult to harden the casting film 76 so as to achieve sufficient hardness for transportation even if the casting film 76 is cooled.

Accordingly, when the weight of the solid content in the casting film 76 at the time of peeling is 100%, the residual amount of solvent W is preferably at least 140% and at most 320%, more preferably at least 170% and at most 310%, and most preferably at least 200% and at most 300%.

The wet film 54 containing a large amount of solvent is fed to the first tenter 55. In the first tenter 55, the side edge portions of the wet film 54 are pierced and held by pins, and the wet film 54 is transported in accordance with the movements of the pins. While being transported through the first tenter 55, the wet film 54 is dried by dry air supplied from the air duct 79 provided in the first tenter 55.

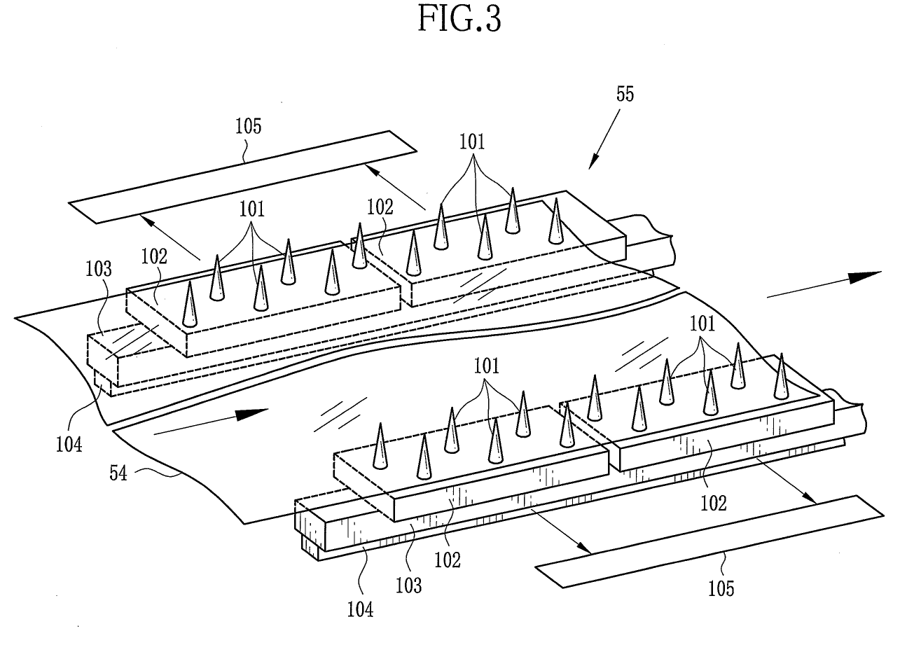

As shown in FIG. 3, the first tenter 55 includes pin plates 102, chains 103, rails 104, and the air duct 79 (see FIG. 2). The pin plates 102 are placed at the side edge portions of the wet film 54 along the transporting path of the wet film 54, and include a plurality of pins 101 respectively. The plurality of pin plates 102 are attached to each chain 103 moving endlessly. Each chain 103 is guided by the rail 104. Each rail 104 has a shifting mechanism 105.

When the wet film 54 reaches a predetermined position in the first tenter 55, the side edge portions of the wet film 54 are pierced and held by the pins 101. The shifting mechanisms 105 shift the rails 104 in the width direction of the wet film 54, and the chains 103 move along the rails 104. In accordance with the movements of the chains 103, the pin plates 102 attached to the chains 103 move in the width direction of the wet film 54 while holding the wet film 54. Thus, tension is applied to the wet film 54 in the width direction.

Immediately after being peeled from the casting drum 75, the wet film 54 contains a large amount of the solvent and has an extremely unstable shape. As a result, it is difficult to transport the wet film 54 using rollers. In addition, the wet film 54 cannot be held by clips. For that reason, in this embodiment, the side edge portions of the wet film 54 are pierced and held by the pins 101. Thus, the wet film 54 can be transported being held in a stable manner.

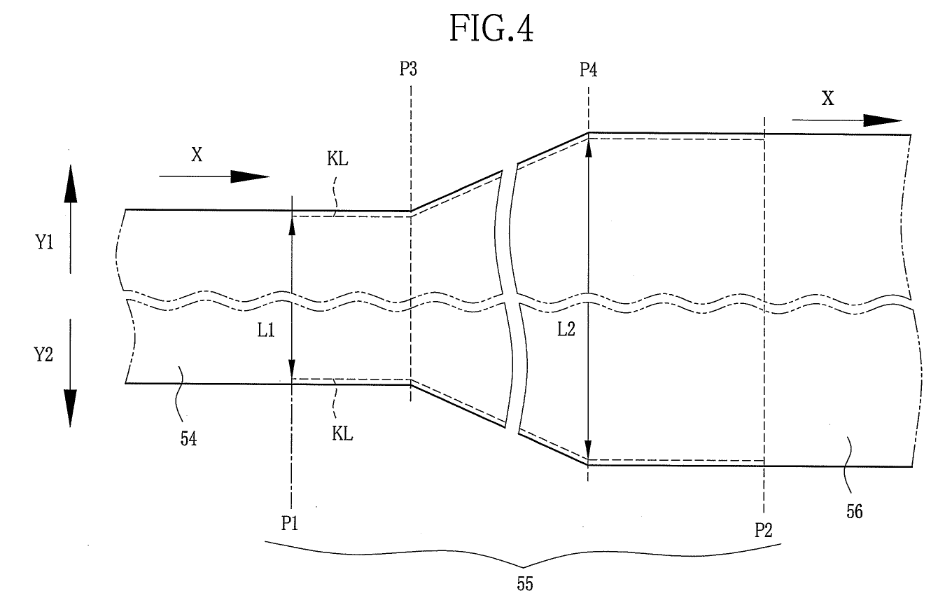

In FIG. 4, an arrow X indicates the transporting direction of the wet film 54. In the first tenter 55, a first position P1 is a position where the pins 101 (see FIG. 3) start to hold (keep) the wet film 54, and a second position P2 is a position where the wet film 54 is released from the pins 101. An inlet of the first tenter 55 is located in the upstream side from the first position P1. An outlet of the first tenter 55 is located in the downstream side from the second position P2. The inlet and the outlet thereof are not shown in FIG. 4.

The solvent gradually evaporates from the wet film 54 peeled from the casting drum 75. The residual amount of solvent tends to be reduced from the residual amount of solvent W at the time of peeing with time. The wet film 54 preferably starts to be stretched in both Y1 and Y2 directions, namely, in the width direction (hereinafter referred to as width direction Y1-Y2) by application of tension as soon as possible.

The stretching of the wet film 54 in the first tenter 55 is preferably completed before the residual amount of solvent W in the wet film 54 reaches at least (W-200) wt %, more preferably at least (W-150) wt %, and most preferably (W-100) wt %. Here, in the first tenter 55, the position where stretching of the wet film 54 is started is a third position P3, and the position where stretching of the wet film 54 is completed is a fourth position P4.

In the first tenter 55, tension is applied to the wet film 54 in the width direction Y1-Y2. Without applying the tension to the wet film 54 in the width direction Y1-Y2 in the first tenter 55, the wet film 54 is loosened due to the self weight or shrinks in the width direction Y1-Y2 in accordance with evaporation of the solvent. In order to prevent the loosening of the wet film 54, the tension is applied to the wet film 54 in the width direction Y1-Y2. It is preferable to apply the tension to the wet film 54 symmetrically with respect to a center in the width direction of the wet film 54. This helps to uniformly control molecular orientation in the wet film 54 in the width direction.

Since the wet film 54 is transported, tension is constantly applied to the wet film 54 in the transporting direction X. Therefore, the molecules of cellulose acylate in the wet film 54 tend to be oriented to the transporting direction X. In view of the above, in order to increase Re especially in the width direction while suppressing the increase of Rth, it is necessary to relax the degree of molecular orientation in the wet film 54 in the transporting direction X and further increase the degree of molecular orientation in the wet film 54 in the width direction.

In addition to prevent the loosening of the wet film 54, when the tension is applied to the wet film 54 in the width direction Y1-Y2, it is possible to increase the degree of molecular orientation in the wet film 54 in the width direction Y1-Y2. Thereby, it is possible to increase the degree of molecular orientation in the wet film 54 in the width direction Y1-Y2 relative to the degree of molecular orientation of cellulose acylate in the wet film 54 in the transporting direction X.

Further, in general, it is difficult to adjust molecular orientation in the film in the thickness direction thereof unless the thickness of the film is adjusted. Since the film is produced so as to have a predetermined width, the molecular orientation in the thickness direction is limited to a predetermined degree. Therefore, in order to control the Rth, the molecular orientation in the transporting and width directions is adjusted.

A width of the wet film 54 at the inlet of the first tenter 55 (hereinafter referred to as a first width) is denoted by L1. With the application of the tension to the wet film 54 in the width direction Y1-Y2, the first width L1 is increased to a second width L2. Hereinafter, the process described above is referred to as a first width increasing process. Thereafter, the second width L2 is kept unchanged. In order to keep the second width L2 unchanged, the tension is applied to the wet film 54 in the width direction Y1-Y2. The reason in that the wet film 54 tends to shrink when the solvent evaporates from the wet film 54. In FIG. 4, imaginary lines KL denote the innermost positions with respect to the width direction of the side edge portions of the wet film 54 which are pierced and held (kept) by the pins 101. The first and second widths L1 and L2 denote distances between the opposing film keeping lines KL.

A width increasing ratio of the wet film 54 between the third position P3 and the fourth position P4 is set to not less than 5% and not more than 30%. The width increasing ratio is a ratio of the increased width of the film due to the width increasing with respect to the width thereof before the width increasing. For example, the width increasing ratio of wet film 54 in the first tenter 55 is calculated by a mathematical expression denoted by 100×(L2−L1)/L1.

The width of the wet film 54 starts to be increased when the residual amount of solvent is W wt % at the earliest, and before the residual amount of solvent reaches preferably (W-100) wt %, more preferably (W-90) wt %, and most preferably (W-80) wt %, the width increasing is completed. Thereby, it is possible to increase the degree of molecular orientation in the width direction while decreasing the degree of molecular orientation in the transporting direction. When the width increasing is started after the residual amount of solvent becomes less than (W-100) wt %, the above effect is hardly obtained. The reason is that solidification of the wet film 54 is enhanced due to the drying.

Further, when the width increasing ratio is less than 5%, almost no effect is obtained in the degree of the molecular orientation in the width direction Y1-Y2. On the contrary, when the width increasing ratio is more than 30%, depending on the residual amount of solvent, the wet film 54 may be torn along the film keeping lines KL or the like. Accordingly, in the width direction Y1-Y2 of the wet film 54, the wet film 54 is stretched only within the range corresponding to the width increasing ratio of 30%, and the degree of molecular orientation in the width direction is not made higher than that corresponding to the width increasing ratio of 30%.

In the first stretching process, after the first width increasing process, it is preferable that there is a width non-increasing process for drying the wet film 54 while keeping the width thereof unchanged until the residual amount of solvent reaches 20 wt %. The reason is that the width non-increasing process makes it possible to achieve the effect for transporting the intermediate film 56 and the film 52 in a stable manner without breaking them in subsequent transporting paths.

Since the intermediate film 56 is transported in the processes after passing the first tenter 55, the tension is applied to the intermediate film 56 in the transporting direction X during transportation. Therefore, it is difficult to prevent molecular orientation in the transporting direction X. However, due to the stretching in the first tenter 55, the molecular orientation in the wet film 54 in the width direction Y1-Y2 can be generated. Accordingly, there causes a constant balance between the degree of molecular orientation in the transporting direction X and the degree of molecular orientation in the width direction Y1-Y2 in the intermediate film 56.

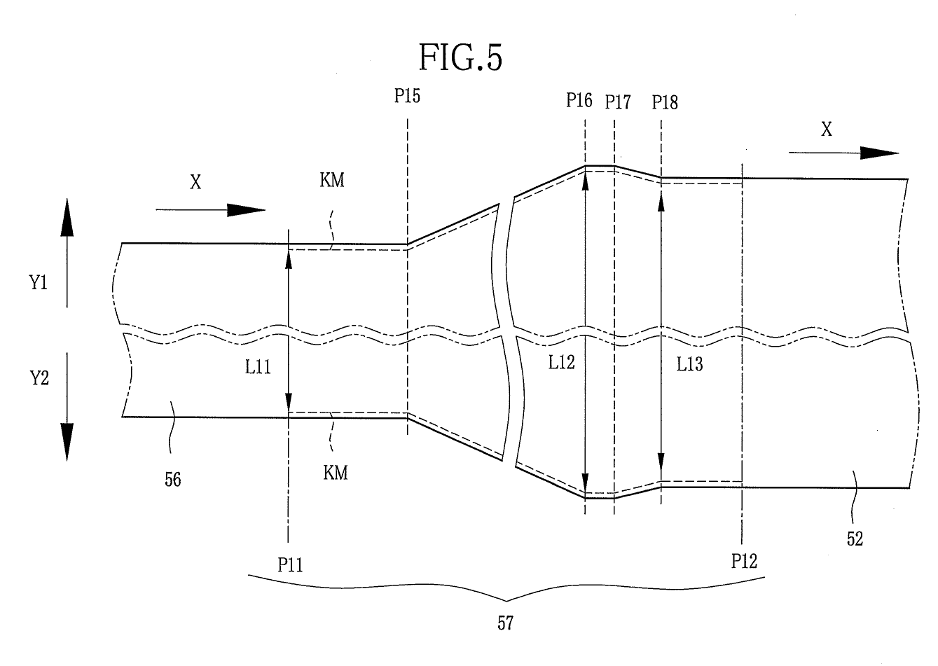

Next, the intermediate film 56 is fed to the second tenter 57 to be subject to the second stretching process. In FIG. 5, an arrow X indicates the transportation direction of the intermediate film 56. A first position P11 is a position where a holding device starts to hold the intermediate film 56 in the second tenter 57, and a second position P12 is a position where the holding device releases the intermediate film 56 in the second tenter 57. Note that the inlet of the second tenter 57 is in the upstream side from the first position P11. The outlet thereof is in the downstream side from the second position P12. The inlet and the outlet are not shown in FIG. 5.

In the second tenter 57, the intermediate film 56 having the residual amount of solvent lower than that of the wet film 54 is transported, and therefore unlike the first tenter 55, the second tenter 57 may be a tenter having clip-type holding devices for holding both edge portions of the intermediate film 56 instead of the pin-type holding devices.

Since the solvent evaporates in the first tenter 55, the residual amount of solvent in the intermediate film 56 at the inlet of the second tenter 57 is at least 0.01 wt % and at most 20 wt %, preferably at least 0.05 wt % and at most 15 wt %, andmost preferably at least 0.1 wt % and at most 10 wt %. Since the intermediate film 56 is further hardened in comparison with the wet film 54, the intermediate film 56 is heated to be softened in the second tenter 57. The softened intermediate film 56 is stretched by application of tension to the intermediate film 56 in the width direction thereof.

A width of the intermediate film 56 at the inlet of the second tenter 57 (hereinafter referred to as a first width) is denoted by L11. With the application of the tension to the intermediate film 56, the first width L11 is increased to a second width L12. Hereinafter, the process described above is referred to as a second width increasing process. Thereafter, the second width L12 may be kept unchanged in subsequent processes. Alternatively, the second width L12 may be decreased. In this case, a reduced width (hereinafter referred to as a third width) is referred to as L13. In either case, the tension is applied to the film 52 in the width direction Y1-Y2. To reduce the width of intermediate film 56, a shrinking force of the intermediate film 56 is utilized. The width of the intermediate film 56 is controlled by the shrinking force thereof and the tension applied to the intermediate film 56. In FIG. 5, imaginary lines KM denote the innermost positions with respect to the width direction of the side edge portions of the intermediate film 56 which are held (kept) by holding device. The first to third widths L11 to L13 denote distances between the opposing film keeping lines KM.

A fifth position P15 is a position where the width increasing of the intermediate film 56 is started. A sixth position P16 is a position where the width increasing of the intermediate film 56 is completed. The width is increased from a first width L11 to a second width L12. A seventh position P17 is a position where the width decreasing of the intermediate film 56 is started. An eighth position P18 is a position where the width decreasing is completed. The width is decreased from the second width L12 to the third width L13.

The width increasing ratio from the fifth position P15 to the sixth position P16 is at least 10% and at most 60%, more preferably at least 15% and at most 55%, and most preferably at least 20% and at most 50%. When the width increasing ratio is 10% or less, almost no effect is obtained in the degree of molecular orientation in the width direction. Further, when the width increasing ratio is 60% or more, the intermediate film 56 may be torn in some cases.

The residual amount of solvent in the intermediate film 56 is lower than that in the wet film 54, and the intermediate film 56 is hardened, and therefore is not easily torn. Therefore, it is possible to increase the width increasing ratio in the second tenter 57 in comparison with the first tenter 55. Further, the intermediate film 56 at the outlet of the first tenter 55 has a predetermined ratio between the degree of molecular orientation in the width direction and that in the transporting direction due to the stretching in the first tenter 55. The ratio is determined by the stretching in the width direction in the first tenter 55. By the stretching in the first tenter 55, the degree of molecular orientation in the transporting direction is relaxed. When the degree of molecular orientation in the width direction in the intermediate film 56 is increased in the second tenter 57, it is possible to obtain the film 52 having the degree of molecular orientation in the width direction larger than that in the transporting direction. Thereby, it is possible to achieve the Re which is high in the width direction in the film 52.

Conventionally, the intermediate film 56 is not stretched in the width direction in the second tenter 57, and the wet film 54 containing high residual amount of solvent is not stretched in the width direction in the first tenter 55. On the other hand, according to the present invention, it is possible to obtain a film having optical properties in which the value of Re is high, the value of haze is low, and the value of Rth is smaller than the value of Re.

Width decreasing process may be performed after the width increasing process regardless of the residual amount of solvent. Accordingly, the seventh position P17 is the same as or in the downstream side from the sixth position P16. The width decreasing may be completed at any point before the intermediate film 56 reaches the eighth position P18.

It is preferable that the width decreasing ratio is at most 10%. In the present invention, the second width L12 may be kept unchanged without the width decreasing. Accordingly, the width decreasing ratio is in a range of zero to 10%. The width decreasing after the width increasing can improve the degree of molecular orientation in view of stability in size decreased due to the heating. When the width decreasing ratio is more than 10%, the effect of the width increasing performed prior to the width decreasing may be reduced in some cases. The width decreasing ratio is calculated by a mathematical expression denoted by 100×(L12−L13)/L13.

Although the first stretching process is performed in the first tenter 55 and the second stretching process is performed in the second tenter 57 in this embodiment, the first and second stretching processes may be performed in the same tenter.

As shown in FIG. 1, after the film 52 is dried until the residual amount of solvent reaches a predetermined value in the second tenter 57, the both side edge portions of the film 52 are cut off by the edge slitting device 58. The cut-off side edge portions are sent to the crusher 85 using a cutter blower (not shown). The crusher 85 crushes the cut-off side edge portions into chips. The chips are reused for the dope production, and thus the raw material is effectively used. Note that, the process of cutting the both side edge portions of the film 52 may be omitted. However, it is preferable to perform this cutting process at any point between the dope casting process and the film winding process.

The film 52 whose both side edge portions are cut off is sent to the drying chamber 60 and further dried. In the drying chamber 60, the film 52 is bridged over the rollers 59 and transported. The inner temperature of the drying chamber 60 is not particularly limited. However, it is preferable that the inner temperature thereof is set at a value in a range of 50° C. to 160° C. It is more preferable to divide the drying chamber 60 into plural sections in the transporting direction of the film 52 so as to change the temperature of air supplied to each section. In addition, it is preferable to provide a pre-drying chamber (not shown) between the edge slitting device 58 and the drying chamber 60 to pre-dry the film 52, because changes in shapes and conditions of the film 52 caused by abrupt increase in the film temperature can be prevented in the drying chamber 60. The solvent vapors in the drying chamber 60 are adsorbed and recovered by the adsorption and recovery device 86. After the solvent content is removed from air, the air is supplied again to the drying chamber 60 as dry air.

The film 52 is cooled to the approximately room temperature in the cooling chamber 61. Note that, in a case where the moisture control chamber is provided between the drying chamber 60 and the cooling chamber 61, it is preferable to blow air adjusted at a predetermined temperature and humidity to the film 52 in the moisture control chamber. Thereby, curling and winding defects of the film 52 can be prevented.

In the solution casting method, there are various processes such as the drying process and the process of cutting the both side edge portions of the film, between the peeling of the film from the support and the winding of the film. In each process, or between the processes, the film 52 is mainly supported or transported by the rollers. As such rollers, there are driving rollers and non-driving rollers. The non-driving rollers determine the transporting path of the film and improve stability in transportation of the film, mainly.

The neutralization device 62 sets the voltage applied to the film 52 at a predetermined value during the transportation of the film 52. It is preferable that the applied voltage after neutralization is in a range of −3 kV to +3 kV. In addition, preferably, knurling is provided, by the pair of knurling rollers 63, to both side edge portions of the film 52. It is preferable that a height of the knurling has a value in a range of 1 μm to 200 μm.

The film 52 is wound by the winding shaft 87 in the winding chamber 64 to form a film roll. It is more preferable to wind the film 52 while predetermined tension is applied to the film 52 by the press roller 88. It is preferable to gradually change the tension applied to the film 52 from the start to the end of winding, which prevents excessive tightening of the film roll. It is preferable that a length of the film 52 to be wound is not less than 100 m. The width of the film 52 to be wound is preferably in a range of 600 mm to 3400 mm, and more preferably in a range of 1400 mm to 2300 mm. However, the present invention is also applicable to films having the width larger than 3400 mm. In addition, the present invention is also applicable to production of thin films having the thickness of 15 μm to 100 μm.

Next, according to a second embodiment of the present invention, a method for producing the film 52 with use of the solution casting apparatus 27 is described hereinbelow. The components equivalent to those in the first embodiment are denoted by the same reference numerals and the description thereof will be omitted in this embodiment.

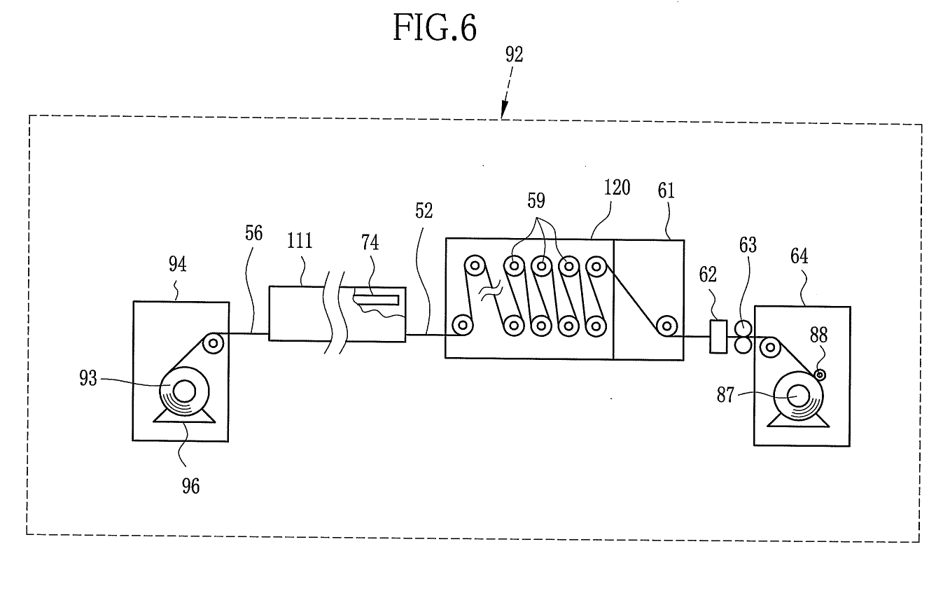

In FIG. 6, in an off-line stretching apparatus 92 of the second embodiment of the present invention, the intermediate film 56 is unrolled from an intermediate film roll 93 and fed to a second tenter 111. In the second tenter 111, the intermediate film 56 is stretched in the width direction. In this case, as shown in FIG. 2, in order to form the intermediate film roll 93, the intermediate film 56 discharged from the first tenter 55 of the first embodiment is guided to the drying chamber 60 without passing through the second tenter 57 of the first embodiment and dried in the drying chamber 60. Thereafter, the dried intermediate film 56 is sent to the cooling chamber 61, and then to the film winding chamber 64, and wound into the intermediate film roll 93 in the film winding chamber 64 in solution casting apparatus 27.

The off-line stretching apparatus 92 includes a film feeding chamber 94, a second tenter 111, a stress relaxation chamber 120, the cooling chamber 61, the film winding chamber 64 in this order. In the second tenter 111, the intermediate film 56 is heated and stretched. In the stress relaxation chamber 120, the film 52 is heated so as to relax stress, which is applied to the film 52 by stretching.

The film feeding chamber 94 includes a film feeding device 96 to which the intermediate film roll 93 is set. Amounting shaft (not shown) is mounted to the film feeding device 96. The intermediate film roll 93 is set to the mounting shaft, and the intermediate film 56 is fed from the feeding chamber 94. The intermediate film 56 of the intermediate film roll 93 has predetermined Re and Rth set in the first tenter 55 (see FIG. 2). Moreover, in order to continuously feed the plural intermediate film rolls 93 each having predetermined Re and Rth different from each other to the second tenter 111, a plural of the film feeding devices 96 may be disposed.

Since the second tenter 111, the cooling chamber 61, and the film winding chamber 64 are the same as those in the first embodiment, the detailed description thereof will be omitted.

According to the first embodiment, stretching is performed in the first tenter 55 and the second tenter 57 in a sequential manner. On the contrary, according to the second embodiment, the intermediate film 56 stretched in the first tenter 55 is unrolled from the intermediate film roll 93 and stretched in the second tenter 111. The intermediate film 56, in which the degree of molecular orientation in the transporting direction and that in the width direction are different from each other, is stretched under the predetermined condition in the second tenter 111 in the off-line stretching apparatus 92. Thereby, it is possible to adjust the values of Re and Rth corresponding to each of plural intermediate films 56. For example, the intermediate film roll 93 of the intermediate film 96 having predetermined Re and Rth is stored once, and as needed, thermal stretching is performed in the second tenter 111 to produce a film having a necessary combination of Re and Rth. In a case where there are disposed plural film feeding devices 96, the changing of the film feeding devices 96 for feeding the intermediate film 56 and the changing of the stretching conditions in the second tenter 111 are performed. Thereby, the plural kinds of intermediate films 56 are stretched sequentially, and therefore it is possible to efficiently produce plural kinds of films whose Re and of Re are different from each other.

According to the present invention, the first width increasing process and the second width increasing process are performed. The wet film whose residual amount of solvent is large is subjected to the first width increasing process. The intermediate film in a dried state is stretched in the width direction in the second width increasing process. Accordingly, it is possible to produce the film whose value of Re/haze is at least 130 in which the value of Re is high and the value of haze is suppressed to low.

Hereinbelow, concrete examples of the present invention are described, however the present invention is not limited thereto.

### EXAMPLE 1

The dope 21 having the following composition was produced using the dope production apparatus 10 shown in FIG. 1.

| | |
|---|---|
| Cellulose triacetate (TAC) | 100 pts. wt. |
| (degree of substitution: 2.94, viscometric average degree | |
| of polymerization: 305.6%, viscosity of 6 mass | |
| % of dichloromethane solution: 350 mPa · s) | |
| Dichloromethane (first component of the solvent) | 390 pts. wt. |
| Methanol (second component of the solvent) | 60 pts. wt. |
| Citric acid ester mixture (a mixture of citric acid, citric | 0.006 pts. wt. |
| acid monoethyl ester, citric acid diethyl ester, and citric | |
| acid triethyl ester) | |
| Fine particles (silicon dioxide, average particle | 0.05 pts. wt. |
| diameter: 15 nm, Mohs hardness: approximately 7) | |
| N-N′-di-m-toluyl-N″-p-methoxyphenyl-1,3,5-triazine- | 8 pts. wt. |
| 2,4,6-triamine (retardation increasing agent) | |

Plural films 52 were produced from the above dope 21 using the solution casting apparatus 27 shown in FIG. 2. The speed for transporting the film 52 was set to 35 (m/min). The film 52 was formed so as to have a thickness of 45 μm. The residual amount of solvent in the casting film 76 at the time of peeling it was 250 wt %. The residual amount of solvent in the wet film 54 at the time of completing stretching it in the first tenter 55 was 150 wt %. During the stretching, the width increasing ratio in the first tenter 55 was 20%, and the width increasing ratio in the second tenter 57 was 40%. In examples 1 to 8, the film 52 satisfying the production conditions of the present invention was formed. In Comparative Examples 1 to 7, the film 52 not satisfying the production conditions of the present invention was formed.

### EXAMPLE 2

In Example 2, the conditions were the same as those in Example 1 except that stretching was performed at the width increasing ratio of 10% in the second tenter 57.

### EXAMPLE 3

In Example 3, the conditions were the same as those in Example 1 except that stretching was performed at the width increasing ratio of 60% in the second tenter 57.

### EXAMPLE 4

In Example 4, the conditions were the same as those in Example 1 except that stretching was performed at the width increasing ratio of 5% in the first tenter 55.

### EXAMPLE 5

In Example 5, the conditions were the same as those in Example 1 except that stretching was performed at the width increasing ratio of 30% in the first tenter 55.

### EXAMPLE 6

In Example 6, the conditions were the same as those in Example 1 except that stretching was performed with the residual amount of solvent in the wet film 54 of 200 wt % at the time of completing increasing the width of it in the first tenter 55.

### EXAMPLE 7

In Example 7, the conditions were the same as those in Example 1 except that stretching was performed with the residual amount of solvent of 200 wt % in the casting film 76 at the time of peeling it and the residual amount of solvent of 100 wt % in the wet film 54 at the time of completing increasing the width of it in the first tenter 55.

### EXAMPLE 8

In Example 8, the conditions were the same as those in Example 1 except that stretching was performed with the residual amount of solvent of 180 wt % in the casting film 76 at the time of peeling it and the residual amount of solvent of 80 wt % in the wet film 54 at the time of completing increasing the width of it in the first tenter 55.

### COMPARATIVE EXAMPLE 1

In Comparative Example 1, the conditions were the same as those in Example 1 except that stretching was performed at the width increasing ratio of 2% in the first tenter 55.

### COMPARATIVE EXAMPLE 2

In Comparative Example 2, while the residual amount of solvent in the casting film 76 at the time of peeling it and the residual amount of solvent in the wet film 54 at the time of completing increasing the width of it in the first tenter 55 were the same as those in Example 1, the stretching was performed at the width increasing ratio of 35% in the first tenter 55. As a result, in the first tenter 55, the wet film 54 was torn and it was impossible to send the wet film 54 to the second tenter 57. Accordingly, it was impossible to obtain the film 52.

### COMPARATIVE EXAMPLE 3

In Comparative Example 3, the conditions were the same as those in Example 1 except that stretching was performed with the residual amount of solvent of 140 wt % in the wet film 54 at the time of completing increasing the width of it in the first tenter 55.

### COMPARATIVE EXAMPLE 4

In Comparative Example 4, the conditions were the same as those in Example 1 except that stretching was performed with the residual amount of solvent of 200 wt % in the casting film 76 at the time of peeling it, namely in the wet film 54, and the residual amount of solvent of 80 wt % in the wet film 54 at the time of completing increasing the width of it in the first tenter 55.

### COMPARATIVE EXAMPLE 5

In Comparative Example 5, the conditions were the same as those in Example 1 except that stretching was performed with the residual amount of solvent of 180 wt % in the casting film 76 at the time of peeling it and the residual amount of solvent of 60 wt % in the wet film 54 at the time of completing increasing the width of it in the first tenter 55.

### COMPARATIVE EXAMPLE 6

In Comparative Example 6, the residual amount of solvent in the casting film 76 at the time of peeling it was 240 wt %, and the width increasing was not performed in the first tenter 55. Namely, the stretching was performed at the width increasing ratio of 0% in the first tenter 55 and the width increasing ratio of 40% in the second tenter 57. Other conditions were the same as those in Example 1.

### COMPARATIVE EXAMPLE 7

In Comparative Example 7, the residual amount of solvent in the casting film 76 at the time of peeling it was 120 wt % which was lower than that of the present invention. In accordance with this, the residual amount of solvent in the wet film 54 in the first tenter 55 was also lowered. The stretching was performed with the width increasing ratio of 10% in the first tenter 55, and with the width increasing ratio of 40% in the second tenter 57. Other conditions were the same as those in Example 1.

The values of Re, Rth, and haze of the film 52 obtained in Examples 1 to 8 and the film obtained in Comparative Examples 1 to 7 are measured. The respective values are shown in Table 1. Note that the measurement of Re is performed by taking a sample from a part of the film 52 wound in the winding chamber 64 and measuring the value of Re in the sample film. Each value of the Re (unit: nm) is under the condition of 25° C., 60% RH, concretely. Each value of the Rth (unit: nm) is under the condition of 25° C., 60% RH.

In order to measure the value of haze, light is applied to the film and light transmission is measured. Then, the measured light transmission is substituted for a formula: Haze value Th (Unit: %)=100×scattered light transmission Td/all light transmission Tt. The light transmission is measured under the condition of 25° C., 60% RH.

Among the films having Re of at least 30 nm, the films having Rth/Re of at least 1 and at most 2.5 are extremely excellent for use in the phase difference film of the polarizing plate, the films having Rth/Re of at least 2.5 and at most 3.5 can be used for the phase difference film of the polarizing plate. The films having Rth/Re of more than 3.5 cannot be used for the phase difference film of the polarizing plate.

Additionally, the film whose value of Re/Haze is at least 130 is excellent for use in the phase difference film of the polarizing plate. On the contrary, the film whose value of Re/Haze is less than 130 is equivalent to the conventional phase difference films.

On the basis of values of Re, Rth/Re, and Re/haze, the films are evaluated by the following criteria. The evaluation results are shown in Table 1.
E: All of 30 mn≦Re, 1≦Rth/Re≦2.5, and 130≦Re/haze are satisfied.
G: all of 30 mn≦Re, 2.5≦Rth/Re≦3.5, and 130≦Re/haze are satisfied.
F: One of 3.5≦Rth/Re, and Re/haze≦130 is satisified.

In Comparative Examples 1, and 3 to 7, since Rth is high, the value of Rth/Re is not less than 3.5, and therefore the film is not suitable for being used as the phase difference film of the polarizing plate. Additionally, the value of Re/haze was less than 130. In Comparative Example 2, since the width increasing ratio is increased in the first tenter, the wet film was torn, and it was impossible to perform width increasing in the second tenter. On the other hand, as to the films in Examples 1 to 8 satisfying the conditions of the present invention, the value of Rth/Re is at most 2.5. Additionally, the value of Re/haze is at least 130. Therefore, according to the present invention, it is possible to obtain a film having optical properties in which Re is at least 30, the Rth is smaller than the Re, and the haze is low such that the value of Re/haze is at least 130.

TABLE 1

| | | | WIR (%) | | | | | | | |
|---|---|---|---|---|---|---|---|---|---|---|
| | RAS (wt %) | | 1st | 2nd | Re | Rth | Rth/Re | | | |
| | PT | WICT | tenter | tenter | (nm) | (nm) | (—) | ER | Haze | Re/Haze |
| Ex 1 | 250 | 150 | 20 | 40 | 60 | 110 | 1.8 | E | 0.4 | 150 |
| Ex 2 | 250 | 150 | 20 | 10 | 40 | 80 | 2.0 | E | 0.3 | 133 |
| Ex 3 | 250 | 150 | 20 | 60 | 80 | 120 | 1.5 | E | 0.5 | 160 |
| Ex 4 | 250 | 150 | 5 | 40 | 55 | 110 | 2.0 | E | 0.4 | 138 |
| Ex 5 | 250 | 150 | 30 | 40 | 65 | 120 | 1.8 | E | 0.4 | 163 |
| Ex 6 | 250 | 200 | 20 | 40 | 60 | 110 | 1.8 | E | 0.4 | 150 |
| Ex 7 | 200 | 100 | 20 | 40 | 60 | 110 | 1.8 | E | 0.4 | 150 |
| Ex 8 | 180 | 80 | 20 | 40 | 60 | 130 | 2.2 | E | 0.4 | 150 |
| Com 1 | 250 | 150 | 2 | 40 | 45 | 130 | 2.9 | F | 0.4 | 113 |
| Com 2 | 250 | 150 | 35 | — | — | — | — | — | — | — |
| Com 3 | 250 | 140 | 20 | 40 | 60 | 160 | 2.7 | F | 0.5 | 120 |
| Com 4 | 200 | 80 | 20 | 40 | 60 | 180 | 3.0 | F | 0.6 | 100 |
| Com 5 | 180 | 60 | 20 | 40 | 60 | 190 | 3.2 | F | 0.7 | 86 |
| Com 6 | 240 | — | 0 | 40 | 50 | 200 | 4.0 | F | 0.4 | 125 |
| Com 7 | 120 | 10 | 10 | 40 | 55 | 220 | 4.0 | F | 0.6 | 92 |

PT: peeling time
WICT: width increasing completing time in first tenter
ER: evaluation result
RAS: residual amount of solvent
WIR: width increasing ratio

The present invention is not to be limited to the above embodiments, and on the contrary, various modifications will be possible without departing from the scope and spirit of the present invention as specified in claims appended hereto.

What is claimed is:

1. A film producing method comprising:
casting dope onto a moving support to form a casting film, said dope containing cellulose acylate and solvent;
peeling said casting film after being solidified by cooling as a film from said support;
subjecting said film to first stretching in its width direction while drying said film, said solvent contained in said film being evaporated therefrom by the drying;
subjecting said film after said first stretching to second stretching in its width direction while heating said film;
increasing the width of said film during said first stretching until the residual amount of said solvent contained in said film reaches (W-100) wt %, the increased width being not less than 105% and not more than 130% of the width before the width increasing; and
increasing the width of said film during said second stretching, the increased width being not less than 110% and not more than 160% of the width before the width increasing,
wherein
W: the residual amount of solvent (unit; wt %) contained in said casting film at the time of peeling said casting film from said support.
